(19) United States
(12) Patent Application Publication
(10) Pub. No.: US 2026/0049916 A1
(43) Pub. Date: Feb. 19, 2026

(54) METHOD AND APPARATUS FOR CALCULATING A VIBRATORY METER Q

(71) Applicant: MICRO MOTION, INC., Boulder, CO (US)

(72) Inventors: George Alexander MACDONALD, Winnersh (GB); Andrew S. KRAVITZ, Frederick, CO (US)

(73) Assignee: MICRO MOTION, INC., Boulder, CO (US)

(21) Appl. No.: 19/367,435

(22) Filed: Oct. 23, 2025

Related U.S. Application Data
(63) Continuation of application No. 18/001,778.

(51) Int. Cl. G01N 11/16; G01N 9/00

(52) U.S. Cl. CPC G01N 11/16; G01N 9/002; G01N 2009/006

(57) ABSTRACT

A vibrating meter (100) is provided being operable to determine at least one of a viscosity and a density of a fluid therein. The vibrating meter (100) comprises a driver (112), a vibrating element (104) vibratable by the driver (112), and operable to be in contact with the fluid. A vibrating sensor (114) is configured to detect a vibrational response of the vibrating element (104). Meter electronics (118) is configured to send an excitation signal to the driver (112) and to receive the vibrational response and is further configured to measure a first vibrational response point and a second vibrational response point of the vibrational response. The second vibrational response point is one of interpolated and extrapolated from other measured response points. The meter electronics (118) is further configured to calculate a Q of the vibrating element (104) using the first vibrational response point and the second vibrational response point.

### CROSS-REFERENCE TO RELATED APPLICATIONS

This application is a continuation of application Ser. No. 18/001,778, which is the National Stage of International Application No. PCT/US2020/041112, filed Jul. 8, 2020.

### TECHNICAL FIELD

The embodiments described below relate to vibratory meters and, more particularly, to density and viscosity meters.

### BACKGROUND

Vibrating meters, including densitometers and viscometers, are important tools used to measure a density or a viscosity of a fluid. Vibrating meters may comprise a vibrating element, such as a fork, a cylinder, or a planar resonator, etc. that is exposed to a fluid under test. One example of a vibrating meter comprises a cylinder cantilever mounted with an inlet end coupled to an existing pipeline or other structure and the outlet end free to vibrate. The member can be vibrated at resonance and the resonant response frequency can be measured. The density of the fluid under test can be determined by measuring the reduced response frequency of the vibrating element. According to well-known principles, the resonant frequency of the vibrating element will vary inversely with the density of the fluid that contacts the conduit.

Viscosity is a fluid characteristic that describes flow resistance. A common definition of viscosity is a measure of the internal friction of a fluid. In particular, this internal friction becomes apparent when a layer of fluid is made to move in relation to another layer. Thus, viscosity is often described as the resistance experienced by one portion of a material moving over another portion of that material. Viscosity is commonly used to characterize petroleum fluids, such as fuels, oils, and lubricants, and often they are specified in the trading and classification of petroleum products. For example, kinematic viscosity for petroleum products is commonly measured in a capillary viscometer by a standard method such as that described by the American Society for Testing and Materials (ASTM) D445 standard. Such measurements involve measuring the time for a fixed amount of liquid to flow under gravity through a calibrated glass capillary under a repeatable force at a given temperature. The capillary tube viscometer has been principally defined by the Hagen-Poiseuille Equation. In a Newtonian fluid, the shear stress is proportional to the shear rate, and the proportionality constant is called the viscosity.

Meters that utilize mechanical resonators, such as vibratory tuning forks, may derive viscosity by balancing the Navier Stokes equation and Newton's Laws of Motion, yielding an equation of the form:

$$μ = A + \frac{B}{{Q}^{2}} \times \frac{1}{ρ \times {ω}_{o}^{3}} \qquad ( 1 )$$

Where μ is the fluid viscosity, ρ is the fluid density, ω₀ is the angular resonant frequency undamped (2πf₀), A is a constant relating to the Q of the resonator in vacuum, and B is a constant relating to the stiffness, mass and geometry of the sensor. The Q is a dimensionless parameter that describes how underdamped an oscillator or resonator is.

The density and resonant frequency are related by an equation of the form:

$$ρ = C + \frac{D}{{f}^{2}} \qquad ( 2 )$$

Where C and D are constants relating to the stiffness, mass and geometry of the resonator thus giving:

$$μ = A + \frac{B}{{Q}^{2}} \times \frac{1}{( C + \frac{D}{{f}^{2}} ) \times {( 2 π {f}_{0} )}^{3}} \qquad ( 3 )$$

For simplicity the resonant frequency can be regarded as the same as f₀, which is the undamped resonant frequency. For many practical applications a viscosity sensor would be calibrated on similar fluids to those measured in the field, and hence the frequency would be unchanged, so the frequency can be regarded as a constant, and hence the equation can take a form similar to the following:

$$μ = A + \frac{E}{{Q}^{2}} \qquad ( 4 )$$

Where E is essentially a constant based upon the stiffness, mass and geometry of the sensor and the nominal resonant frequency. The equations provided are provided as non-limiting examples.

The principle of using a vibrating sensor for measurement of liquid viscosity is well known. An example of which is the Micro Motion Fork Viscosity Meter (FVM) that is based upon the vibrating-element principle whereby the resonant properties are influenced by the density and viscosity of the fluid. The FVM utilizes this operational principle to determine liquid viscosity. In particular, viscosity is determined by measuring the quality factor (Q) of the resonance and hence damping of the resonator. For example, without limitation, Equation 5 describes one possible method for determining viscosity:

$$Viscosity = {V}_{0} + {V}_{2} / {Q}^{2} \qquad ( 5 )$$

### Where:

V₀ and V₂ are calibration constants.

Q may be measured as resonance frequency divided by bandwidth as shown:

$$Q = \frac{f 0}{( f 1 - f 2 )} Where : f 0 = \frac{( {f}^{1} + {f}^{2} )}{2} \qquad ( 6 )$$

The geometric Q may be calculated as:

$$Q = 1 / [ {( \frac{{T}_{A}}{{T}_{B}} )}^{0.5} - {( \frac{{T}_{B}}{{T}_{A}} )}^{0.5} ] \qquad ( 7 )$$

Where:
T_{A} is the time point of the leading 3 dB bandwidth measurement point
T_{B} is the time point of the trailing 3 dB bandwidth measurement point

FIG. 1 graphically illustrates 3 dB time points T_{A} and T_{B} in terms of time period. FIG. 2 graphically illustrates 3 dB time points F₁, F₀, and F₂ in terms of frequency.

One drawback of the method of alternately measuring the leading and trailing 3 dB points is that the measurement at point B is not taken at the same time as the measurement at point A. Therefore, if the fluid density is changing, then erroneous Q measurements are made. This is illustrated in FIG. 3 in terms of frequency. It will be evident that F₁ is updated on the odd sample numbers and F₂ is updated on the even sample numbers. The Q is calculated every cycle using the latest value of F₁ and F₂, so either F₁ or F₂ will be one cycle out of date, and in this case the calculated Q will oscillate high and low even though the bandwidth and hence Q should be relatively constant.

Q is very sensitive to changes in frequency or time period which is why there is a need for an improved method. Turning again to FIG. 3, for example, the frequency is nominally 1350 Hz and the change in frequency is around 0.09 Hz per sample. Although the frequency drift is very small, the resulting oscillation on the Q measurement is 1% per sample (see FIG. 7). That is to say that the effect on Q is >100 times larger than the underlying frequency drift. This drift could be the result of a steady change in fluid composition or it could arise from a change in temperature.

The present embodiments relate to apparatuses and methods for obtaining readings for F₁ and F₂ which correspond to the same moment in time such that even if the fluid density is changing, the Q measurement is far more accurate.

### SUMMARY

A vibrating meter operable to determine at least one of a viscosity and a density of a fluid therein is provided according to an embodiment. The vibrating meter comprises a driver and a vibrating element vibratable by the driver, and operable to be in contact with the fluid. A vibrating sensor is configured to detect a vibrational response of the vibrating element. Meter electronics are configured to send an excitation signal to the driver and to receive the vibrational response, and are further configured to measure a first vibrational response point and a calculate second vibrational response point of the vibrational response, wherein the second vibrational response point is one of interpolated and extrapolated from other measured response points, and wherein meter electronics is further configured to calculate a Q of the vibrating element using the first vibrational response point and the second vibrational response point.

A method of determining a viscosity or a density of a fluid using a vibrating meter is provided according to an embodiment. The method comprises sending an excitation signal to a driver and driving a vibrating element with the driver. Vibrations of the vibrating element are detected. A first vibrational response point of the vibrational response is measured. A second vibrational response point of the vibrational response is calculated, wherein the second vibrational response point is one of interpolated and extrapolated from other measured response points. A Q of the vibrating element is calculated using the first vibrational response point and the second vibrational response point.

### Aspects

According to an aspect, a vibrating meter is operable to determine at least one of a viscosity and a density of a fluid therein. The vibrating meter comprises a driver and a vibrating element vibratable by the driver, and operable to be in contact with the fluid. A vibrating sensor is configured to detect a vibrational response of the vibrating element. Meter electronics are configured to send an excitation signal to the driver and to receive the vibrational response, and are further configured to measure a first vibrational response point and a calculate second vibrational response point of the vibrational response, wherein the second vibrational response point is one of interpolated and extrapolated from other measured response points, and wherein meter electronics is further configured to calculate a Q of the vibrating element using the first vibrational response point and the second vibrational response point.

Preferably, the meter electronics is configured to determine a viscosity of the fluid using the Q.

Preferably, the first vibrational response point comprises one of a leading 3 dB bandwidth measurement point and a trailing 3 dB bandwidth measurement point, and the second vibrational response comprises one of a leading 3 dB bandwidth measurement point and a trailing 3 dB bandwidth measurement point, and the second vibrational response point is different from the first vibrational response point.

Preferably, the first and second vibrational response points comprise a frequency.

Preferably, the first and second vibrational response points comprise a time period.

Preferably, the vibrating element is cantilevered.

Preferably, the first vibrational response point and a second vibrational response point of the vibrational response correspond to the same moment in time.

Preferably, the other measured response points comprise at least two points.

According to an aspect, a method of determining a viscosity or a density of a fluid using a vibrating meter is provided. The method comprises sending an excitation signal to a driver and driving a vibrating element with the driver. Vibrations of the vibrating element are detected. A first vibrational response point of the vibrational response is measured. A second vibrational response point of the vibrational response is calculated, wherein the second vibrational response point is one of interpolated and extrapolated from other measured response points. A Q of the vibrating element is calculated using the first vibrational response point and the second vibrational response point.

Preferably, the method comprises the step of determining a viscosity of the fluid using the Q.

Preferably, the first vibrational response point comprises one of a leading 3 dB bandwidth measurement point and a trailing 3 dB bandwidth measurement point, and the second vibrational response comprises one of a leading 3 dB bandwidth measurement point and a trailing 3 dB bandwidth measurement point, and the second vibrational response point is different from the first vibrational response point.

Preferably, the first and second vibrational response points comprise a frequency.

Preferably, the first and second vibrational response points comprise a time period.

Preferably, the first vibrational response point and a second vibrational response point of the vibrational response correspond to the same moment in time.

Preferably, the other measured response points comprise at least two points.

### BRIEF DESCRIPTION OF THE DRAWINGS

The same reference number represents the same element on all drawings. It should be understood that the drawings are not necessarily to scale.

FIG. 1 illustrates 3 dB time points T_{A} and T_{B} in time period terms;

FIG. 2 illustrates 3 dB time points F₁ and F₂ in frequency terms;

FIG. 3 illustrates prior art measurement of 3 dB points related to Q calculations;

FIG. 4 illustrates a vibrating meter;

FIG. 5 illustrates measurement of 3 dB points related to Q calculations according to an embodiment;

FIG. 6 illustrates measurement of 3 dB points related to Q calculations according to an alternate embodiment;

FIG. 7 illustrates a comparison of prior art measured Q over time versus measured Q according to embodiments;

FIG. 8 illustrates meter electronics according to an embodiment; and

FIG. 9 illustrates a method of calculating Q according to an embodiment.

### DETAILED DESCRIPTION

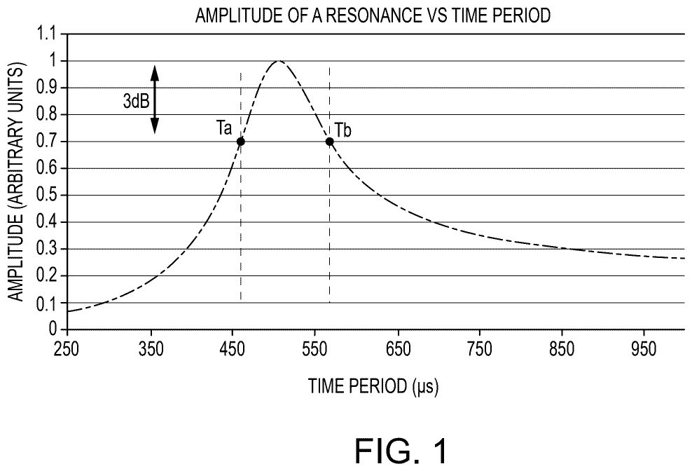

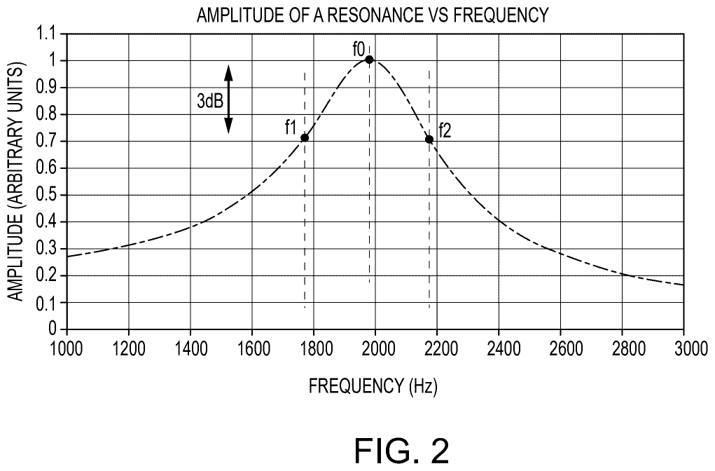

FIGS. 1-9 and the following description depict specific examples to teach those skilled in the art how to make and use the best mode of embodiments of a vibrating meter. For the purpose of teaching inventive principles, some conventional aspects have been simplified or omitted. Those skilled in the art will appreciate variations from these examples that fall within the scope of the present description. Those skilled in the art will appreciate that the features described below may be combined in various ways to form multiple variations of the vibrating meter. As a result, the embodiments described below are not limited to the specific examples described below, but only by the claims and their equivalents.

The embodiments provided relate to densitometers and viscometers and related methods for accurately calculating Q measurements of vibratory members. In particular, readings for the leading 3 dB bandwidth measurement point (T_{A}) and trailing 3 dB bandwidth measurement point (T_{B}) are utilized in Q measurement calculations which correspond to the same moment so that even if the fluid density is changing, the Q measurement remains accurate.

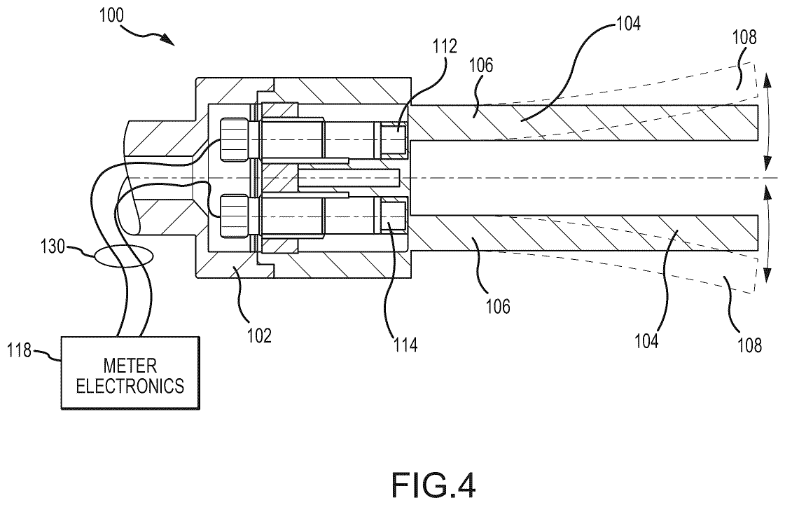

FIG. 4 depicts a vibrating meter 100. The vibrating meter 100 may be configured to measure a density and/or viscosity of a fluid, such as a liquid or a gas, for example. Vibrating meter 100 includes a housing 102 with a vibrating element 104 located at least partially within the housing 102. Housing 102 helps to retain the fluid pressure as vibrating element 104 oscillates. A portion of housing 102 is cut away. In examples, vibrating meter 100 may be placed in-line in an existing pipeline. In further examples, however, the housing 102 may comprise closed ends with apertures to receive a fluid sample. In many instances, the housing 102 or vibrating element 104 may include flanges or other members for operatively coupling vibrating meter 100 to a pipeline or similar fluid delivering device in a fluid-tight manner. In the example of vibrating meter 100, vibrating element 104 is cantilever mounted to housing 102 at first end 106. Vibrating element 104 is free to vibrate at a second end 108.

The example vibrating meter 100 is immersive, meaning that the fluid under measurement is found all around vibrating element 104. The vibrating element 104 may take the form of a tube, sheet, modified sheet, fork (as illustrated), rod, or any other shape known in the art. The vibrating element 104 may be affixed at one or both ends, and may be cantilevered in some embodiments, such as that illustrated. According to the example shown, the vibrating element 104 may include a plurality of fluid apertures (not shown) near the first end 106. The fluid apertures can be provided to allow some of the fluid entering the vibrating meter 100 to flow between the housing 102 and the vibrating element 104. In other examples, apertures may be provided in the housing 102 to expose the fluid under test to the outer surface of the vibrating element 104. In further examples, however, fluid may enter the vibrating meter through channels in the metal work near the first end 106.

Further shown in FIG. 4 is a driver 112 and a vibrating sensor 114 positioned within a cylinder 116. The driver 112 and vibrating sensor 114 may comprise coils, but other implementations are also possible, such as piezo sensors, optical sensors, strain gages, etc. If an electric current is provided to the coil, a magnetic field is induced in the vibrating element 104 causing the vibrating element 104 to vibrate. Conversely, the vibration of the vibrating element 104 induces a voltage in the vibrating sensor 114. The driver 112 receives a drive signal from a meter electronics 118 in order to vibrate the vibrating element 104 at one of its resonant frequencies in one of a plurality of vibration modes, including for example simple bending, torsional, radial, or coupled type. The vibrating sensor 114 detects the vibration of the vibrating element 104, including the frequency at which the vibrating element 104 is vibrating and sends the vibration information to the meter electronics 118 for processing. As the vibrating element 104 vibrates, the fluid contacting the vibrating element's wall, and the fluid a short distance from the cylinder will vibrate along with the vibrating element 104. The added mass of the fluid contacting the vibrating element 104 lowers the resonant frequency. The new, lower, resonant frequency of the vibrating element 104 is used to determine the density of the fluid. The resonance response, or the quality factor, may also be used to determine the viscosity of the fluid. If a fluid under test is present, the Q of the vibrating element 104 will change inversely proportionally to the fluid viscosity.

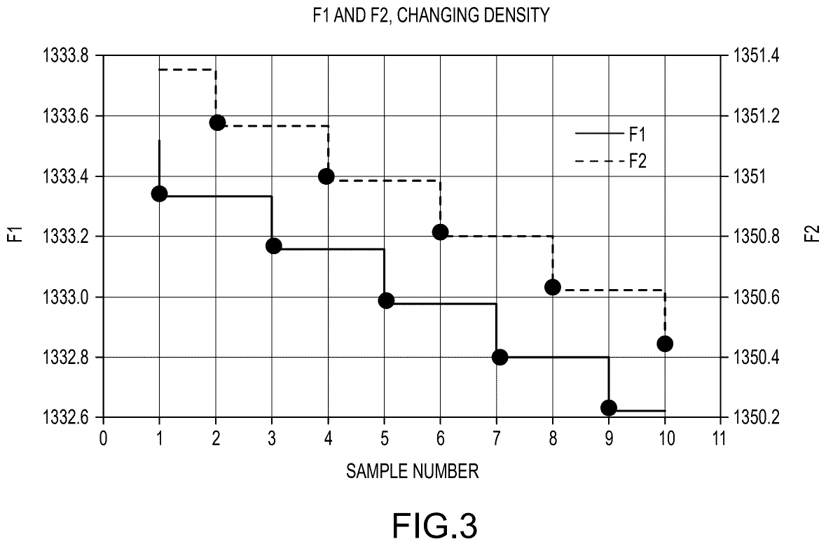

In embodiments, a first frequency response point and a second frequency response point are measured for use in Q calculations. Alternatively, first and second time points are measured. Turning to FIGS. 3 and 4, in embodiments, readings of a frequency response of the vibrating element 104 for at least one of the leading 3 dB bandwidth measurement point (F₁) and trailing 3 dB bandwidth measurement point (F₂) is to fit a straight line, such that two values are used from the same time period. Such values may be consecutive, as illustrated, or non-consecutive. Such readings are computed by the meter electronics 118. It should be noted that either time period or frequency may be utilized in relation to 3 dB bandwidth measurement points.

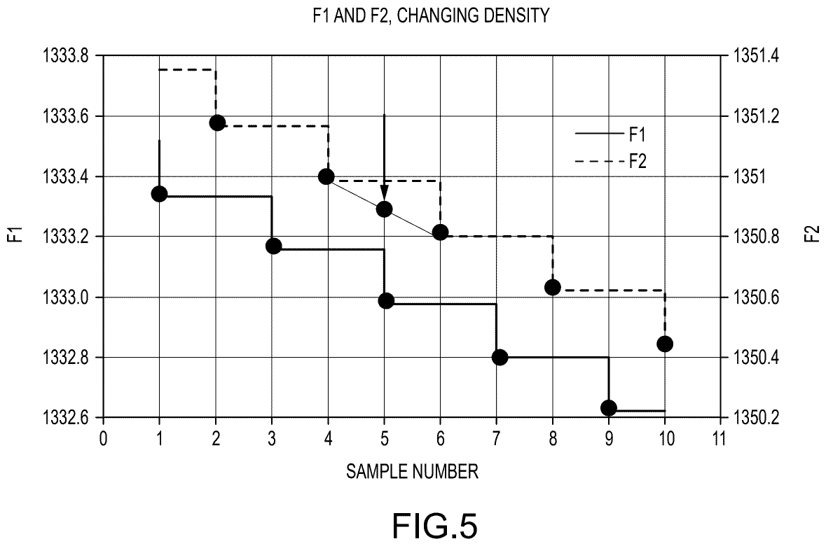

In FIG. 5, it is illustrated by example that the F₁ value is interpolated between points of actual measurement. In this case, a value is interpolated for F₂ between sample numbers 4 and 6. It will be clear that this point in time corresponds with the point where F₁ is measured—i.e. sample 5. This point corresponds to the arrow shown in FIG. 5. The interpolated F₂ value is then utilized in conjunction with the measured F₁ value at the time of F₁ value measurement to calculate Q. It should be noted that this is merely an example, and the F₁ value could be interpolated, with the F₂ measurement being utilized for Q calculations. Furthermore, the sample numbers are also only provided for the purpose of illustrative example, and any sample numbers, consecutive or non-consecutive, may be used.

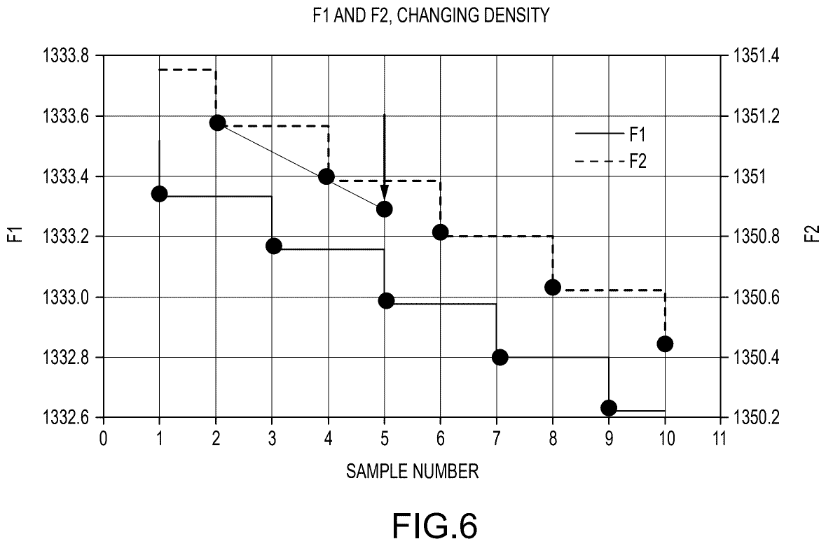

A disadvantage of this approach is that calculations for Q always lag behind the live measurement. An alternative method that does not result in a lag is illustrated in FIG. 6. In this embodiment, a line is fit between consecutive F₂ measurements at sample number 2 and 4, and then extrapolated to a time point where sample number 5 is taken. This point corresponds to the arrow shown in FIG. 6. It should be noted again that this is merely an example, and the F₁ value could be extrapolated, with the F₂ measurement being utilized for Q calculations. Furthermore, the sample number is also only provided for the purposes of the example, and any sample numbers, consecutive or non-consecutive, may be used.

In the above examples, only two points are used for calculating an interpolated or extrapolated value. Multiple points, averages, running averages, slope equations or the like, and combinations thereof may also be used for calculating interpolated and/or extrapolated values.

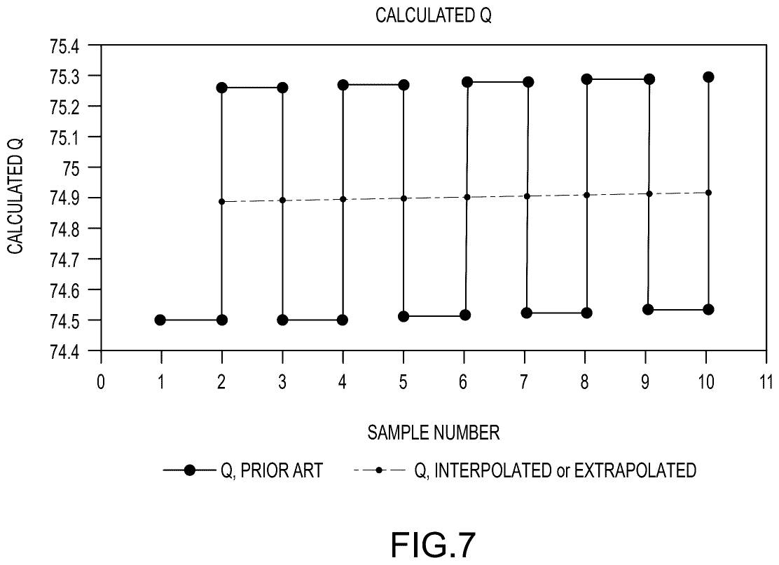

FIG. 7 illustrates the nature of the calculated Q values over time where density is changing utilizing the offset 3 dB bandwidth measurement points that are employed by prior art devices. It will be clear that the measured Q is not stable. Superimposed upon this line is an example of the improved Q value measurement as a result of interpolation or extrapolation, as shown in FIGS. 3 and 4.

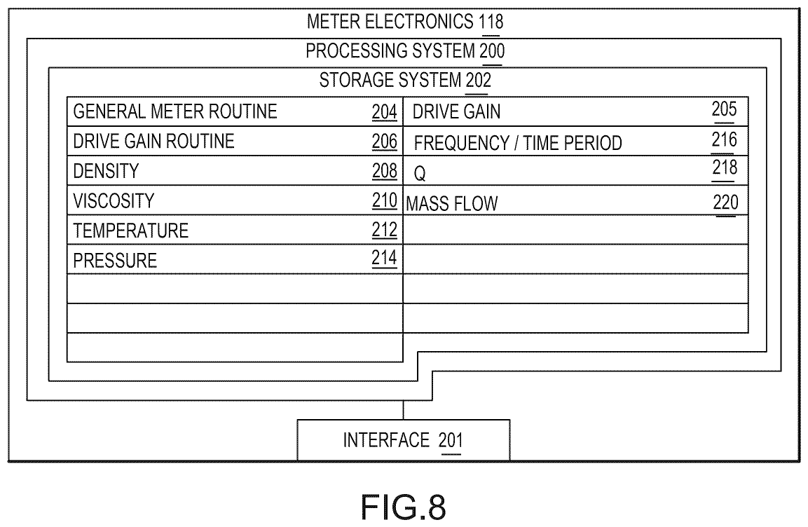

FIG. 8 is a block diagram of the meter electronics 118 according to an embodiment. In operation, the vibrating meter 100 provides various measurement values that may be outputted including one or more of a measured or averaged value of density, viscosity, and flow rate.

The vibrating meter 100 generates a vibrational response. The vibrational response is received and processed by the meter electronics 118 to generate one or more fluid measurement values. The values can be monitored, recorded, saved, totaled, and/or output.

The meter electronics 118 includes an interface 201, a processing system 200 in communication with the interface 201, and a storage system 202 in communication with the processing system 200. Although these components are shown as distinct blocks, it should be understood that the meter electronics 118 can be comprised of various combinations of integrated and/or discrete components.

The interface 201 may be configured to couple to the leads and exchange signals with the driver 112, vibrating sensors 114, and temperature or pressure sensors (not shown), for example. The interface 201 may be further configured to communicate over a communication path to external devices.

The processing system 200 can comprise any manner of processing system. The processing system 200 is configured to retrieve and execute stored routines in order to operate the vibrating meter 100. The storage system 202 can store routines including a general meter routine 204. The storage system 202 can store measurements, received values, working values, and other information. In some embodiments, the storage system stores a mass flow (m) 220, a density (ρ) 208, a viscosity (μ) 210, a temperature (T) 212, a pressure 214, a drive gain 205, a frequency and/or time period 216, a Q 218, routines such as the drive gain routine 206 and any other variables or routines known in the art. Other measurement/processing routines are contemplated and are within the scope of the description and claims.

The general meter routine 204 can produce and store fluid quantifications and flow measurements. The general meter routine 204 can generate viscosity measurements and store them in the viscosity 210 storage of the storage system 202, and/or density measurements and store them in the density 208 storage of the storage system 202, for example. The viscosity 210 value may be determined from the Q 218, as previously discussed and as known in the art.

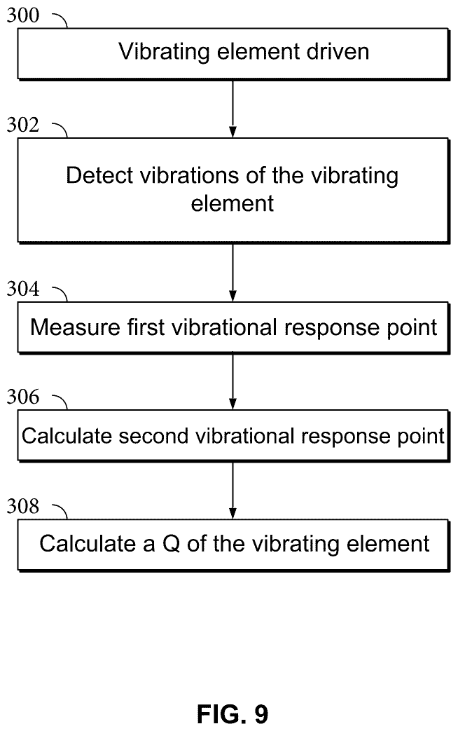

FIG. 9 depicts a method in accordance with an embodiment. The method begins with step 300. In step 300, a vibrating element 100 is driven to vibrate by the driver 112. An excitation signal that controls the driver 112 is sent from meter electronics 118.

The method continues with step 302. In step 302, the vibrations of the vibrating element 104 are detected.

In step 304, a first vibrational response point of the vibrational response is measured.

In step 306, a second vibrational response point of the vibrational response is calculated. The second vibrational response point is calculated via one of interpolation and extrapolation from other measured response points.

A Q of the vibrating element 104 is calculated in step 308 using the first vibrational response point and the second vibrational response point, as described herein.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein may be applied to other vibrating meters, and not just to the embodiments described above and shown in the accompanying figures. Accordingly, the scope of the embodiments described above should be determined from the following claims.

We claim:

1. A vibrating meter (100) operable to determine at least one of a viscosity and a density of a fluid therein, comprising:
a driver (112);
a vibrating element (104) vibratable by the driver (112), and operable to be in contact with the fluid;
a vibrating sensor (114) configured to detect a vibrational response of the vibrating element (104); and
meter electronics (118) configured to send an excitation signal to the driver (112) and to receive the vibrational response, and further configured to measure a first vibrational response point and a calculate second vibrational response point of the vibrational response, wherein the second vibrational response point is one of interpolated and extrapolated from other measured response points, and wherein meter electronics (118) is further configured to calculate a Q of the vibrating element (104) using the first vibrational response point and the second vibrational response point, wherein the first vibrational response point and a second vibrational response point of the vibrational response correspond to the same moment in time.

2. The vibrating meter (100) of claim 1, wherein the meter electronics (118) is configured to determine a viscosity of the fluid using the Q.

3. The vibrating meter (100) of claim 1, wherein the first vibrational response point comprises one of a leading 3 dB bandwidth measurement point (F₁) and a trailing 3 dB bandwidth measurement point (F₂), and the second vibrational response comprises one of a leading 3 dB bandwidth measurement point (F₁) and a trailing 3 dB bandwidth measurement point (F₂), and the second vibrational response point is different from the first vibrational response point.

4. The vibrating meter (100) of claim 3, wherein the first and second vibrational response points comprise a frequency.

5. The vibrating meter (100) of claim 1, wherein the vibrating element (104) is cantilevered.

6. The vibrating meter (100) of claim 1, wherein the other measured response points comprise at least two points.

7. A method of determining a viscosity or a density of a fluid using a vibrating meter (100) comprising:
sending an excitation signal to a driver (112);
driving a vibrating element (104) with the driver (112);
detecting vibrations of the vibrating element (104);
measuring a first vibrational response point of the vibrational response;
calculating a second vibrational response point of the vibrational response, wherein the second vibrational response point is one of interpolated and extrapolated from other measured response points, wherein the first vibrational response point and a second vibrational response point of the vibrational response correspond to the same moment in time; and
calculating a Q of the vibrating element (104) using the first vibrational response point and the second vibrational response point.

8. The method of claim 7, comprising the step of determining a viscosity of the fluid using the Q.

9. The method of claim 7, wherein the first vibrational response point comprises one of a leading 3 dB bandwidth measurement point (F₁) and a trailing 3 dB bandwidth measurement point (F₂), and the second vibrational response comprises one of a leading 3 dB bandwidth measurement point (F₁) and a trailing 3 dB bandwidth measurement point (F₂), and the second vibrational response point is different from the first vibrational response point.

10. The method of claim 7, wherein the first and second vibrational response points comprise a frequency.

11. The method of claim 7, wherein the other measured response points comprise at least two points.
